(19) United States
(12) Patent Application Publication
(10) Pub. No.: US 2022/0214449 A1
(43) Pub. Date: Jul. 7, 2022

(54) Method for Performing SAR Acquisitions with Increased Swath Size

(71) Applicant: Thales Alenia Space Italia S.p.A. Con Unico Socio, Roma (IT)

(72) Inventor: Diego Calabrese, Roma (IT)

(73) Assignee: Thales Alenia Space Italia S.p.A. Con Unico Socio, Roma (IT)

(21) Appl. No.: 17/602,596

(22) PCT Filed: Apr. 9, 2020
(86) PCT No.: PCT/IB2020/053411

§ 371 Date: Oct. 8, 2021

(30) Foreign Application Priority Data
Apr. 9, 2019 (IT) 102019000005444

(51) Int. Cl. G01S 13/90

(52) U.S. Cl. CPC G01S 13/9054

(57) ABSTRACT

The present invention concerns a method for performing SAR acquisitions, which comprises performing SAR acquisitions in Spotlight/Stripmap mode of areas/swaths of earth's surface by means of a SAR system carried by an air or space platform along a flight direction, whereby: an azimuth direction is defined by a ground track of the flight direction on the earth's surface, a nadir direction is defined that is orthogonal to the earth's surface, to the flight direction and to the azimuth direction, an across-track direction is defined that lies on the earth's surface and is orthogonal to the azimuth direction and to the nadir direction, and, for each acquired area/swath of the earth's surface, a respective range direction is defined that extends from the synthetic aperture radar system to said acquired area/swath. Performing SAR acquisitions in Spotlight/Stripmap mode of areas/swaths of earth's surface includes contemporaneously acquiring P areas or portions of P swaths in a pulse repetition interval having a predefined time length, P being an integer greater than one. Said P areas/swaths are separated along the across-track direction and are spaced apart from each other along the across-track direction and from the SAR system along the respective range direction by predefined distances. Said predefined time length and said predefined distances are such that to enable contemporaneous acquisition of said P areas or of portions of said P swaths in said pulse repetition interval.

### CROSS-REFERENCE TO RELATED APPLICATIONS

This patent application claims priority from Italian patent application no. 102019000005444 filed on Sep. 4, 2019, the entire disclosure of which is incorporated herein by reference.

### TECHNICAL FIELD OF THE INVENTION

The present invention relates, in general, to remote sensing based on Synthetic Aperture Radar (SAR) and, more specifically, to an innovative method for performing SAR acquisitions that allows meeting conflicting requirements between azimuth resolution and swath size, while limiting hardware complexity in SAR systems.

### STATE OF THE ART

As is known, one of the most important applications of spaceborne and airborne SAR-based Earth Observation (EO) systems is the capability to acquire large areas of the earth's surface with high resolution.

The main SAR acquisition geometry is the so-called Stripmap mode, wherein a SAR sensor carried along a flight direction by an air or space platform (e.g., an aircraft/drone or a satellite/spacecraft) transmits radar signals towards a strip of the earth's surface (known as swath) and then receives the corresponding back-scattered signals therefrom. Typically, the swath mainly extends parallel to an azimuth direction, which is identified by a ground track of the flight direction and which is parallel to said flight direction. Moreover, the swath has a given width along an across-track direction, which lies on the earth's surface and is orthogonal to both the azimuth direction and a nadir direction that passes through the phase center of the antenna of the SAR sensor and that is orthogonal to the earth's surface and to the flight direction (and, hence, also to the azimuth direction). As is known, nominal azimuth resolution of the Stripmap mode is limited to half the physical or equivalent length along the azimuth direction of the SAR sensor's antenna.

Often, in order to improve azimuth resolution, the so-called Spotlight mode is used, which is the main SAR technique to obtain high spatial resolution. In particular, the Spotlight mode involves a continuous, or quasi-continuous, steering of SAR sensor's antenna beam in azimuth during flight so as to illuminate one and the same area of interest of the earth's surface with the transmitted radar signals and then receive the corresponding back-scattered signals therefrom. In this way, persistence time of the SAR sensor on the area of interest is increased and, hence, the azimuth resolution is improved. Unfortunately, the Spotlight mode does not allow to acquire strips, thereby having a strong limitation in acquired area's length along the azimuth direction.

More in general, SAR technology can be considered a mature technology; in fact, nowadays there are countless articles, manuals, patents and patent applications that describe the characteristics and potential thereof; in this regard, reference can be made, for example, to:
the article by A. Currie and M. A. Brown entitled “Wide-swath SAR”, IEE Proceedings of Radar and Signal Processing, vol. 139, no. 2, pp. 122-135, April 1992, which hereinafter will be indicated, for simplicity of description, as Ref1 and which describes various methods for widening the swath observable via a SAR;
the article by G. Krieger et al. entitled “Advanced Concepts for High-Resolution Wide-Swath SAR Imaging”, 8^{th} European Conference on Synthetic Aperture Radar, pp. 524-527, 7 Jun. 2010, which hereinafter will be indicated, for simplicity of description, as Ref2 and which presents various concepts regarding multi-channel SAR systems for creating high-resolution wide-swath SAR images;
the book by J. C. Curlander and R. N. McDonough entitled “Synthetic Aperture Radar: Systems and Signal Processing”, Wiley Series in Remote Sensing, Wiley-Interscience, 1991, which hereinafter will be indicated, for simplicity of description, as Ref3 and which is a manual on SAR systems;
the book by G. Franceschetti and R. Lanari entitled “Synthetic Aperture RADAR Processing”, CRC Press, March 1999, which hereinafter will be indicated, for simplicity of description, as Ref4 and which is another manual on SAR systems;
the article by D. Calabrese entitled “DIscrete Stepped Strip (DI2S)”, EUSAR 2014-10^{th} European Conference on Synthetic Aperture Radar, 3-5 Jun. 2014, Berlin, Germany, which hereinafter will be indicated, for simplicity of description, as Ref5; or, equivalently, EP 2 954 347 B1 and EP 2 956 795 B1, which hereinafter will be indicated, for simplicity of description, as Ref6 and Ref7, respectively;
GB 2 256 765 A, which hereinafter will be indicated, for simplicity of description, as Ref8 and which relates to an imaging apparatus, wherein earth's surface is imaged by means of a SAR system carried by an orbiting satellite—in particular, according to Ref8, a previously transmitted radar pulse is scattered and received along at least two received beams producing a plurality of samples of data per transmitted pulse; this allows the use of a lower Pulse Repetition Frequency (PRF) than a conventional system allowing a wider swath to be imaged whilst still satisfying the Nyquist criterion and maintaining spatial resolution in the azimuth direction;
the article by A. Moreira et al. entitled “A Tutorial on Synthetic Aperture Radar”, IEEE Geoscience and Remote Sensing Magazine, vol. 1, no. 1, 1 Mar. 2013, pp. 6-43, which hereinafter will be indicated, for simplicity of description, as Ref9;
the article by M. Gabele and M. Younis entitled “Comparison of Techniques for Future Spaceborne GMTI”, 8th European Conference on Synthetic Aperture Radar, Aachen, Germany, 7-10 Jun. 2010, pp. 1-4, which hereinafter will be indicated, for simplicity of description, as Ref10; and
the article by Y. Zhang et al. entitled “Effects of PRF variation on spaceborne SAR imaging”, IEEE International Geoscience and Remote Sensing Symposium—IGARSS, Melbourne, Australia, 21-26 Jul. 2013, pp. 1336-1339, which hereinafter will be indicated, for simplicity of description, as Ref11.

As is broadly known in the SAR sector, the azimuth resolution for a SAR acquisition in Stripmap mode is a function of the angular aperture (or angular difference—delta angle) with which a target is observed by the SAR sensor; or, equivalently, the azimuth resolution can be also seen as a function of the time difference (delta time—related to the velocity of the SAR sensor) with which the target is observed. In particular, the azimuth resolution can be expressed by the following equation (for further details, reference cap be made to Ref3 and Ref4):

$$res = \frac{0.886 λ}{2 * delta\_angle}$$

where res denotes the azimuth resolution, λ denotes the wavelength used by the SAR sensor and delta_angle denotes the angular aperture (or angular difference—delta angle) with which the target is observed by the SAR sensor.

Assuming the angular aperture delta_angle as a 3 dB aperture (one-way) of the antenna (=0.886λ/L, where L denotes the physical or equivalent length along the azimuth direction of the antenna of the SAR sensor), the constraint traditionally associated with the azimuth resolution for the Stripmap mode can be obtained, which is equal to L/2 (for further details, reference can be made again to Ref3 and Ref4).

As indicated in SAR literature, mathematical relations exist that link the parameters of the operational modes. In particular, azimuth sampling dictates that the transmission/reception Pulse Repetition Frequency (PRF) is linked to the size of the beam and to the velocity of the SAR sensor (for further details, reference can be made again to Ref3 and Ref4):

$$P R F \geq \frac{2 * α * {v}_{sat}}{L}$$

where a is a parameter dependent on the desired level of ambiguity, vₛₐₜ denotes the velocity of the SAR sensor and L denotes the physical or equivalent length along the azimuth direction of the antenna of the SAR sensor.

The value of the PRF limits the extension of the measured area (swath) in range (for further details, reference can be made again to Ref3 and Ref4):

$$Δ R \leq ( \frac{1}{PRF} - 2 τ ) \frac{c}{2}$$

where ΔR denotes the extension of the measured area (swath) in range, τ denotes the time interval (or duration) of the radar pulse transmitted and c denotes the speed of light.

In view of the foregoing, it is worth noting that wide, unambiguous swath coverage, high azimuth resolution and high sensibility pose conflicting requirements on SAR design. In particular, the requirements of having wide swaths and high azimuth resolutions are in mutual conflict. In fact, on the one hand, a low PRF is preferable to have “more time” to acquire a wide scene in across-track—elevation plane. However, on the other hand, a wide antenna beam is preferable to improve azimuth resolution. Unfortunately, this latter feature requires a high PRF, thereby conflicting with the first requirement.

In addition, high values of PRF can affect range ambiguity, as reported in Ref8: “A further problem exists with a high PRF because pulses from previous cycles return from distant scatterers during the receive period of subsequent cycles, producing an image of a more distant scatterer superimposed on closer detail. This means that imaged features in the third closest swath S3 to the satellite in FIG. 2 are superimposed on features imaged from the second closest swath S2 because the pulse used to image the closest swath S1 returns from more distant scatterers in the third swath S3 during the receiving period of the subsequent cycle.”

In order to improve SAR systems' capabilities and to propose new solutions for overcoming limits of the traditional Stripmap mode, several techniques have been proposed in recent years. Such techniques impose a performance degradation and/or a considerable complication in hardware development.

In particular, in addition to the Spotlight mode and burst modes (e.g., ScanSAR and TOPS) which provide a deterioration in azimuth resolution, in the SAR literature there are different techniques that try to overcome the above conflicting requirements. These techniques can be logically divided into:
space sharing (or space division) techniques;
angular/angle sharing (or angular/angle division) techniques; and
time sharing (or time division) techniques.

Space Sharing Techniques

In order to overcome the above problems, techniques have been proposed in the past that use space division modes, such as, for example, the so-called Displaced Phase Centers (DPC) technique (for further details, reference can be made to Ref1 and Ref2), which requires the use of multiple reception antennas. This can be achieved by using multiple SAR sensors, or by segmenting a single antenna and using multiple reception systems. In particular, according to the DPC technique, a wide beam is transmitted (i.e., small antenna size L) and then simultaneously received with M antennas (of small size like the one used in transmission) arranged along the azimuth direction. The use of multiple reception elements allows to have a larger number of azimuth samples and, hence, to use a lower PRF (for further details, reference can be made to Ref1 and Ref2).

In this respect, FIGS. 1A and 1B schematically illustrate an example of transmission and reception operations according to the DPC technique. In particular, FIG. 1A shows the transmission, by means of an antenna 11, of a wide beam in azimuth (i.e., a beam that is wide along the azimuth direction—namely, the flight direction), which results in a small equivalent dimension of the antenna 11 along the azimuth direction. Instead, FIG. 1B shows simultaneous reception performed by M receivers and M “small” antennas 12 (or a large one partitioned into M sub-blocks) arranged along the azimuth direction, wherein a beam similar to the transmitted one is used also for reception.

The biggest contraindication of the DPC technique is the complexity; in fact, this technique requires the simultaneous use of M receivers and M “small” antennas (or a large one partitioned into M sub-blocks) and, hence, requires high transmission power to achieve adequate product sensitivity. Furthermore, the SAR literature points out some criticalities at algorithm level regarding sensitivity to errors of knowledge of the M phase centers, as well as undesirable effects on the ambiguity level.

In the SAR literature, there are some variants that try to reduce these criticalities, such as the so-called High Resolution Wide-Swath (HRWS) technique, which also involves partitioning in elevation in order to “follow” the beam in elevation, thereby increasing directivity and consequently product sensitivity.

Angular Sharing Techniques

The aim of the techniques that use angle division modes is similar to that of the techniques that use space division modes, but the additional samples are acquired by sampling in different directions. In particular, there are two main logics: angular division in elevation and angular division in azimuth.

Angular division in elevation (in this connection, reference can be made, for example, to the so-called Multiple Elevation Beam (MEB) technique described in Ref1) involves simultaneous acquisition with multiple antennas/reception systems and a single transmitter (with wide swath), or more directive transmissions (for further details, reference can be made to Ref1). In this way, a plurality of acquisitions is obtained in Stripmap mode with nominal azimuth resolution (approximately L/2). In order to reduce problems of range ambiguities, the SAR literature proposes squinting the individual beams in elevation.

An example of the MEB technique based on the use of a single transmitter and multiple receiving channels is well described in Ref9: “The top right of FIG. 27 provides an illustration, where three narrow Rx beams follow the echoes from three simultaneously mapped image swaths that are illuminated by a broad Tx beam.”

Additionally, also Ref11 specifies that a single continuous zone can be acquired divided in more than one zone.

For the sake of performance increase, the combination of the MEB technique with other techniques is also proposed in the SAR literature. For example, Ref10 states: “If also elevation channels are provided such that SCORE [10] can be applied, multiple swaths can be imaged at the same time.”

FIGS. 2A, 2B and 2C schematically illustrate an example of transmission and reception operations according to the MEB technique. In particular, FIG. 2A shows the transmission by an airborne/spaceborne SAR system 21 of a wide beam in elevation (i.e., a beam that is wide along the across-track direction, which is denoted by y). Instead, FIGS. 2B and 2C show reception by the airborne/spaceborne SAR system 21 that simultaneously uses narrower beams with different pointing in elevation so as to acquire a single wide swath 22 (i.e., a swath that is wide along the across-track direction y—FIG. 2B), or three narrower swaths 23, 24 and 25, which are spaced apart from each other along the across-track direction y (FIG. 2C).

Instead, angular division in azimuth (in this respect, reference can be made, for example, to the Single Phase Centre MultiBeam (SPCMB) technique described in Ref1) involves transmission by means of a single, wide-beam antenna and simultaneous reception by use of M narrower beams pointed in different directions in azimuth organized to acquire the overall illuminated area. In this way, a wide beam is obtained (thereby improving azimuth resolution), but similarly to the Spotlight mode, the single reception channels correctly sample a different angle portion. These channels will then be recombined during processing in order to obtain a synthesized delta angle M times greater, thus improving azimuth resolution (for further details, reference can be made to Ref3 and Ref4).

In this respect, FIGS. 3A and 3B schematically illustrate an example of transmission and reception operations according to the SPCMB technique. In particular, FIG. 3A shows the transmission by an airborne/spaceborne SAR system 31 of a wide beam in azimuth (i.e., a beam that is wide along the azimuth direction—namely, the flight direction). Instead, FIG. 3B shows reception by the airborne/spaceborne SAR system 31 that simultaneously uses narrower beams with different pointing in azimuth so as to acquire a wide swath (i.e., a swath that is wide along the azimuth direction).

In general, techniques based on angular division in azimuth have many criticalities with respect to the ambiguity level; in fact, lateral lobes of the antenna used in transmission and of the single antennas used in reception interact, raising the level of the ambiguities.

The space and angle division concepts are well summarized in Ref2, which in section 2 states: “Several proposals resolve the azimuth resolution vs. wide swath coverage dilemma by combining a multi-channel radar receiver with a small aperture transmitter illuminating a wide area on the ground. Examples are the squinted multiple beam SAR . . . , the displaced phase center antenna (DPCA) technique . . . , the Quad Array SAR system . . . , and the High-Resolution Wide-Swath (HRWS) SAR system”.

Also in this case, the biggest contraindication of the angular division techniques is the complexity; in fact, these techniques involve the simultaneous use of M receivers and M “small” antennas (or a large one partitioned into M sub-blocks) and, hence, require high transmission power to achieve adequate product sensitivity.

Time Sharing Techniques

The basic idea of time (or pulse) sharing techniques is to divide the acquisitions into a plurality of elementary strips acquired in time sharing by a single SAR using a single receiver and a single, non-partitioned antenna, and to combine them to obtain a product with improved azimuth resolution or to acquire multiple swaths. The basic idea is to perform acquisitions interleaved at Pulse Repetition Interval (PRI) or burst level, in particular acquisitions carried out by changing antenna beam pointing in azimuth or in elevation at each PRI/burst. By using an increased PRF, it is possible to obtain N Stripmap acquisitions having individually a PRF compatible with the size of the antenna. In this way, the values of azimuth ambiguity are not altered and at the same time the sum of the illumination angles allows to synthesize an equivalent antenna with a greater beam (up to N times) or allows the separation of the swath in range into N swaths of smaller size (approximately 1/N—in particular, smaller width along the across-track direction) without affecting other parameters (e.g. resolution, azimuth ambiguity, etc.). For further details, reference can be made to Ref5, Ref6 and Ref7, which concern the above time sharing technique (that is named DIscrete Stepped Strip—DI2S)

In this respect, FIGS. 4A and 4B schematically illustrate an example of transmission and reception operations according to the DI2S technique. In particular, FIG. 4A shows the transmission by an airborne/spaceborne SAR system 41, equipped with a single, non-partitioned antenna and a single receiver, of narrow beams (i.e., beams that are narrow along the azimuth direction) whose pointing in azimuth is varied at PRI/burst level. Instead, FIG. 4B shows reception by the airborne/spaceborne SAR system 41 that uses said narrow beams and varies their pointing in azimuth at PRI/burst level.

The following Table I summarizes the main features/drawbacks of each technique.

TABLE I

| TECHNIQUE | FEATURES/DRAWBACKS |
|---|---|
| Space Sharing | Very high number of receivers; |
| | Synchronization and alignments of the receivers; |
| | High power/High density (antenna partitioned). |
| Angular Sharing | High number of receivers; |
| | High power (antenna partitioned); |
| | Very small swath (significantly increased PRF). |
| Time Sharing | Very small swath (significantly increased PRF). |

### OBJECT AND SUMMARY OF THE INVENTION

A general object of the present invention is that of providing a method for performing SAR acquisitions that allows overcoming, at least in part, the above drawbacks of currently known SAR techniques.

Moreover, a specific object of the present invention is that of providing a method for performing SAR acquisitions that allows acquiring wide-swath, high azimuth resolution SAR images, eliminating (or at least reducing) limitations of currently known SAR techniques.

These and other objects are achieved by the present invention in that it relates to a method for performing SAR acquisitions, as defined in the appended claims.

In particular, the present invention concerns a method for performing SAR acquisitions, comprising performing SAR acquisitions in Spotlight/Stripmap mode of areas/swaths of earth's surface by means of a synthetic aperture radar (SAR) system carried by an air or space platform along a flight direction, whereby:
an azimuth direction is defined by a ground track of the flight direction on the earth's surface,
a nadir direction is defined that is orthogonal to the earth's surface, to the flight direction and to the azimuth direction,
an across-track direction is defined that lies on the earth's surface and is orthogonal to the azimuth direction and to the nadir direction, and,
for each acquired area/swath of the earth's surface, a respective range direction is defined that extends from the SAR system to said acquired area/swath.

Performing SAR acquisitions in Spotlight/Stripmap mode of areas/swaths of earth's surface includes contemporaneously acquiring P areas or portions of P swaths in a pulse repetition interval (PRI) having a predefined time length, P being an integer greater than one.

Said P areas/swaths are separated along the across-track direction and are spaced apart from each other along the across-track direction and from the SAR system along the respective range direction by predefined distances.

Said predefined time length and said predefined distances are such that to enable contemporaneous acquisition of said P areas or of portions of said P swaths in said PRI.

### BRIEF DESCRIPTION OF THE DRAWINGS

For a better understanding of the present invention, preferred embodiments, which are intended purely by way of non-limiting examples, will now be described with reference to the attached drawings (all not to scale), wherein:

FIGS. 1A and 1B schematically illustrate an example of transmission and reception operations according to the space-sharing SAR technique named Displaced Phase Centers (DPC);

FIGS. 2A, 2B and 2C schematically illustrate an example of transmission and reception operations according to the angular-sharing SAR technique named Multiple Elevation Beam (MEB);

FIGS. 3A and 3B schematically illustrate an example of transmission and reception operations according to the angular-sharing SAR technique named Single Phase Centre MultiBeam (SPCMB);

FIGS. 4A and 4B schematically illustrate an example of transmission and reception operations according to the time-sharing SAR technique named DIscrete Stepped Strip (DI2S);

FIGS. 5A, 5B and 5C schematically illustrate a non-limiting example of implementation of a method for performing SAR acquisitions according to a preferred embodiment of the present invention;

FIGS. 6-8 show examples of features/performance of the present invention;

FIGS. 9 and 10 show possible solutions for antennas used in reception according to preferred, non-limiting embodiments of the present invention; and

FIGS. 11-13 show possible solutions for antennas used in transmission according to preferred, non-limiting embodiments of the present invention.

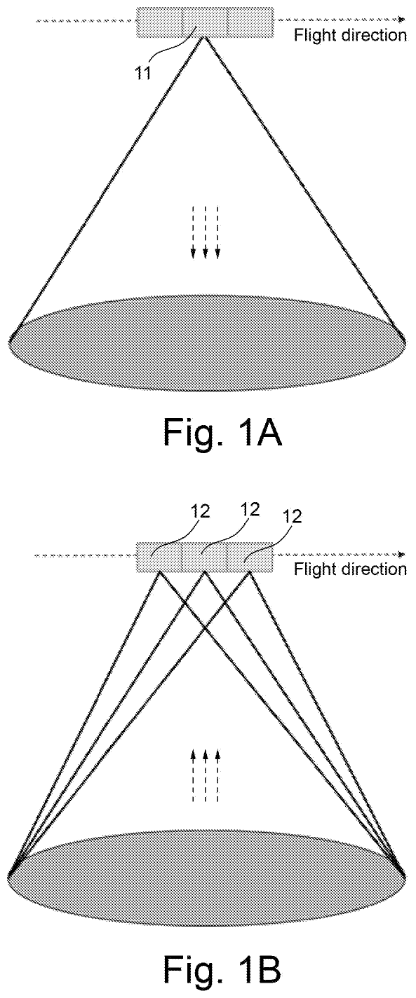

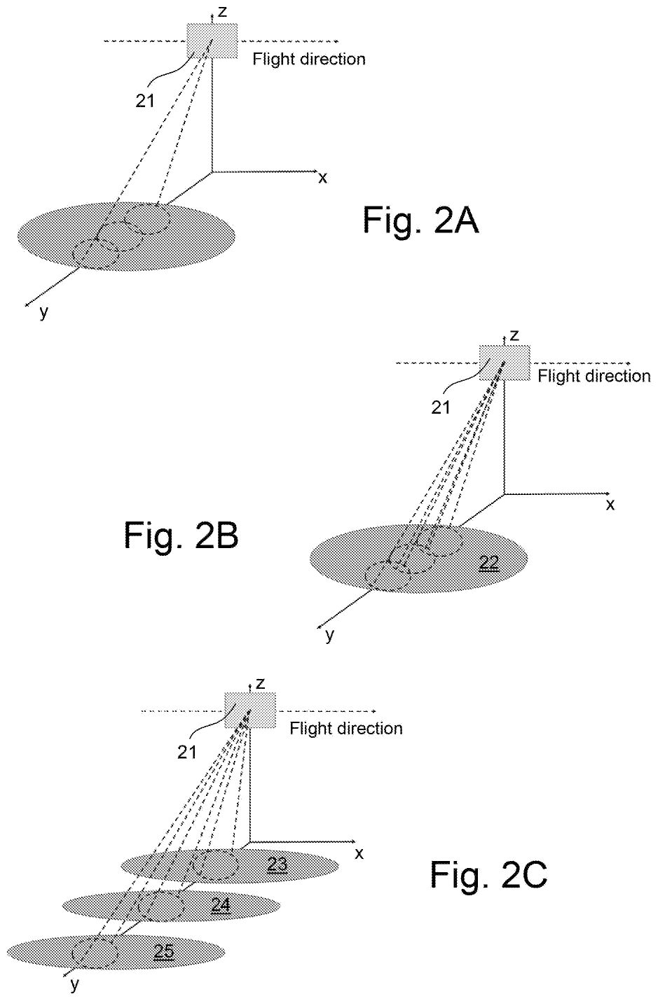

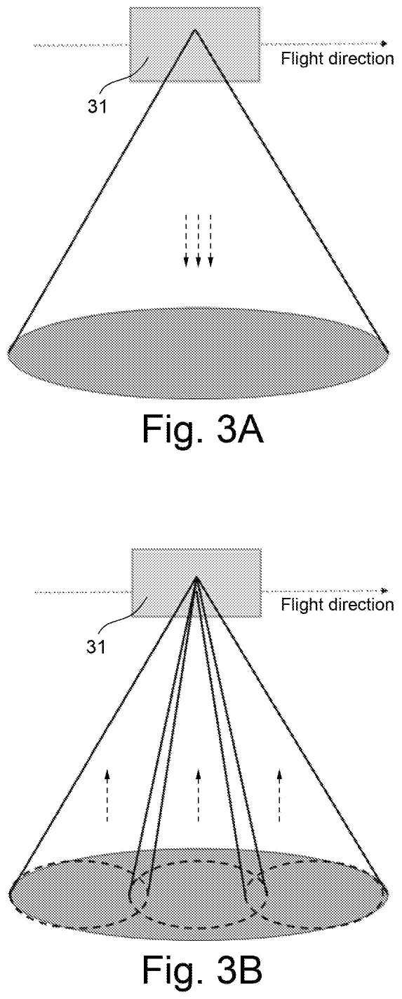

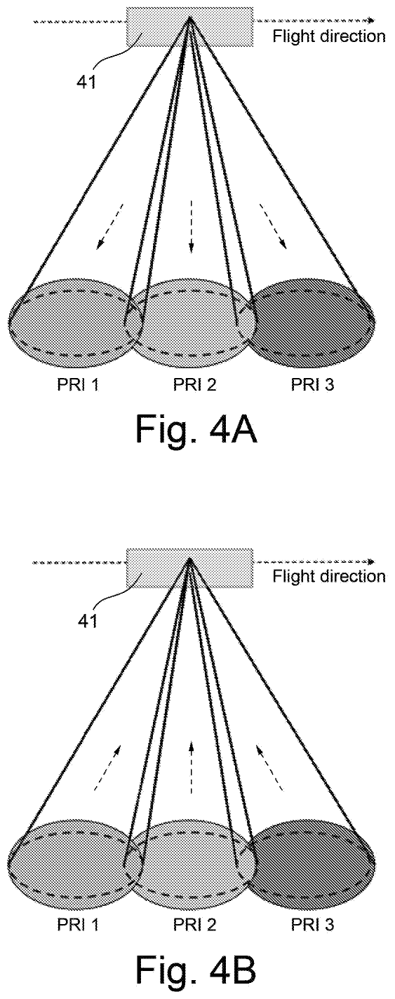

### DETAILED DESCRIPTION OF PREFERRED EMBODIMENTS OF THE INVENTION

The following description is presented to enable a person skilled in the art to make and use the invention. Various modifications to the embodiments will be readily apparent to those skilled in the art, without departing from the scope of the present invention as claimed. Thence, the present invention is not intended to be limited to the embodiments shown and described, but is to be accorded the widest scope of protection consistent with the principles and features disclosed herein and defined in the appended claims.

The present invention stems from Applicant's idea of merging peculiarities of the time-sharing DI2S technique with those of the angular-sharing MEB technique so as to reduce their respective drawbacks and to synergistically combine their respective positive aspects.

In particular, the present invention concerns a method for performing SAR acquisitions that has been named by the Applicant “DIstributed Sparse Sampling for SAR Systems” (DI4S) and that allows acquiring:
SAR images in Stripmap mode of
   multiple swaths with nominal Stripmap azimuth resolution and nominal Stripmap swath size (more specifically, nominal Stripmap swath width), or
   a single swath with nominal Stripmap azimuth resolution and increased swath size (namely, swath width increased with respect to nominal Stripmap swath width); or
SAR images in Spotlight mode of
   multiple areas with nominal Spotlight azimuth resolution and nominal Spotlight area size (more specifically, nominal Spotlight area width), or
   a single area with nominal Spotlight azimuth resolution and increased area size (namely, area width increased with respect to nominal Spotlight area width).

In detail, the present invention concerns a method that comprises performing SAR acquisitions in Spotlight/Stripmap mode of areas/swaths of earth's surface by means of a synthetic aperture radar (SAR) system carried by an air or space platform (e.g., an aircraft/drone/helicopter or a satellite/spacecraft) along a flight direction, whereby:
an azimuth direction is defined by a ground track of the flight direction on the earth's surface,
a nadir direction is defined that is orthogonal to the earth's surface, to the flight direction and to azimuth direction,
an across-track direction is defined that lies on the earth's surface and is orthogonal to the azimuth direction and to the nadir direction, and,
for each acquired area/swath of the earth's surface, a respective range direction is defined that extends from the SAR system to said acquired area/swath.

More specifically, performing SAR acquisitions in Spotlight/Stripmap mode of areas/swaths of earth's surface includes contemporaneously acquiring P areas or portions of P swaths in a pulse repetition interval (PRI) having a predefined time length, wherein P is an integer greater than one (i.e., P>1).

Said P areas/swaths are separated along the across-track direction and are spaced apart from each other along the across-track direction and from the SAR system along the respective range direction by predefined distances.

Said predefined time length and said predefined distances are such that to enable contemporaneous acquisition of said P areas or of portions of said P swaths in said PRI.

Conveniently, contemporaneously acquiring P areas or portions of P swaths in a PRI includes using:
P transmission radar beams that are angularly separated in elevation with respect to the nadir direction so as to be pointed, each, at a respective one of said P areas/swaths, or a single transmission radar beam that is such that to illuminate, with one or more transmitted radar signals, said P areas or portions of said P swaths; and
P reception radar beams that are angularly separated in elevation with respect to the nadir direction so as to be pointed, each, at a respective one of said P areas/swaths.

According to a first specific preferred embodiment of the present invention, the predefined time length and the predefined distances are such that to enable contemporaneous acquisition of said P areas or of portions of said P swaths in each PRI.

Instead, according to a second specific preferred embodiment of the present invention, an operational pulse repetition frequency (PRF) is conveniently used that is increased by T times with respect to the nominal PRF associated with the SAR system, wherein T is an integer greater than one (i.e., T>1) and wherein:
the SAR acquisitions in Spotlight/Stripmap mode are performed in a time division fashion, whereby in each PRI P respective areas or portions of P respective swaths are contemporaneously acquired;
for each PRI, the P respective areas/swaths are separated along the across-track direction and are spaced apart from each other along the across-track direction and from the SAR system along the respective range direction by respective predefined distances; and
the predefined time length and the respective predefined distances associated with the P respective areas/swaths contemporaneously acquired in each PRI are such that the areas or the swaths' portions acquired in T successive PRIs form an overall region that is continuous (i.e., does not comprise “holes”) along the across-track direction.

Conveniently, according to said second specific preferred embodiment of the present invention, for each PRI, the respective P areas/swaths are contemporaneously acquired by using:
P respective transmission radar beams that are angularly separated in elevation with respect to the nadir direction so as to be pointed, each, at a respective one of said P respective areas/swaths, or a single transmission radar beam that is such that to illuminate, with one or more transmitted radar signals, said P respective areas or portions of said P respective swaths; and
P respective reception radar beams that are angularly separated in elevation with respect to the nadir direction so as to be pointed, each, at a respective one of said P respective areas/swaths;

wherein the transmission and reception radar beams used in T successive PRIs form an elevation-continuous angular span (i.e., a continuous angular span without angular interruptions/holes along the across-track direction).

Conveniently, the SAR acquisitions in Spotlight/Stripmap mode are performed by using, in transmission and/or reception, an antenna of the SAR system partitioned into P different zones.

More conveniently, the SAR acquisitions in Spotlight/Stripmap mode are performed by using, in transmission and/or reception, an antenna of the SAR system partitioned into P different zones in elevation (i.e., along the nadir direction).

Conveniently, the SAR acquisitions in Spotlight/Stripmap mode are performed by using different squint angles with respect to the azimuth direction and/or orthogonal waveforms such that to increase range ambiguity performance.

Conveniently, the P×T areas or swaths' portions acquired in T successive PRIs are individually processed, then correlated and, finally, information merging is carried out, so as to reduce/compensate for space errors, such as those related to channel synchronization and Doppler parameter estimation.

As previously explained, one of the constraints limiting swath size in range (or, equivalently, along the across-track direction that corresponds to the ground track of the range direction on the earth's surface) is that, with the known SAR techniques, it is not virtually possible to acquire and receive simultaneously. This constraint is synthesized by the following equation (already explained in the foregoing):

$$ΔR \leq ( \frac{1}{PRF} - 2 τ ) \frac{c}{2} .$$

On the contrary, transmitting towards and receiving from zones that are separated in range (i.e., along the across-track direction), as taught by the present invention, allows to overcome such a constraint and, hence, to increase the size in range (i.e., along the across-track direction) of the acquired swath(s).

Moreover, by using a given PRF (e.g., the nominal one or an increased one) and, hence, a given PRI's time length, it is possible to acquire at the same time different zones separated in range which are spaced apart from each other along the across-track direction and from the used SAR along the respective range direction by predefined distances. In particular, the given PRI's time length and said predefined distances are selected (namely, are determined a priori) so as to enable cotemporaneous acquisition of said different zones. In other words, with the same PRF it is possible to acquire at the same time different zones, if these zones have different rank (transmission and reception distance in PRI).

Conveniently, in order to acquire the P different zones separated in range (i.e., along the across-track direction), P receivers may be used. Moreover, since the P zones are separated in range, there is no impact on range ambiguity level (anyway, it is possible to use different squint angles with respect to the azimuth direction and/or orthogonal waveforms in order to increase range ambiguity performance).

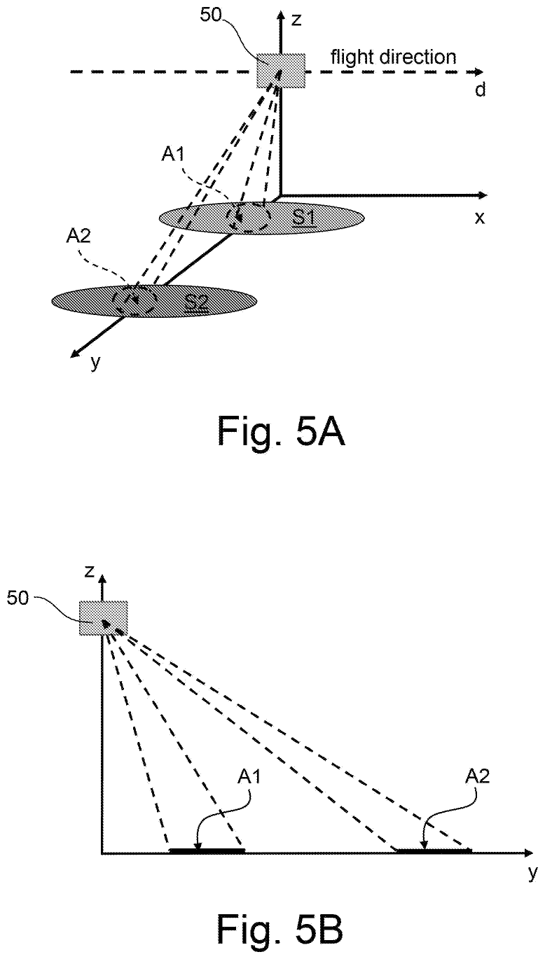

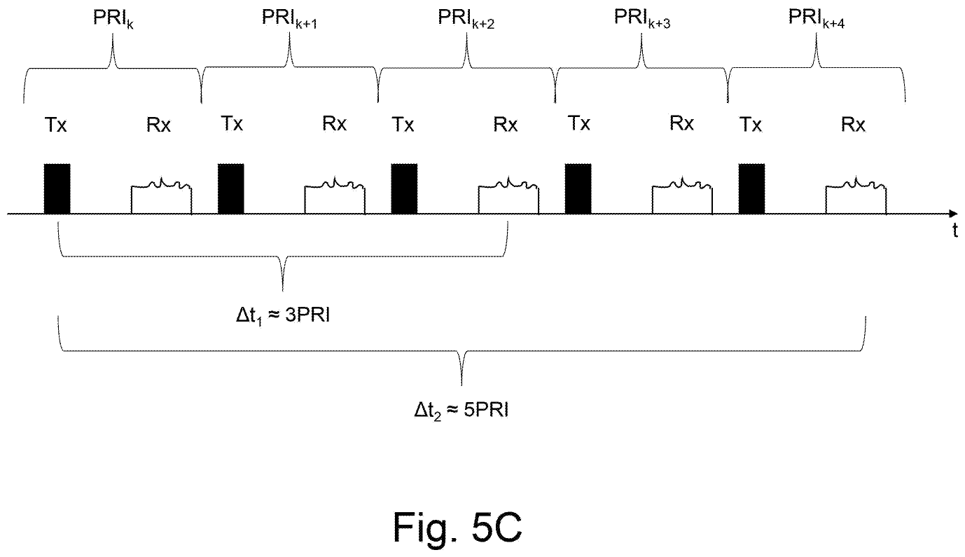

For a better understanding of the present invention, FIGS. 5A, 5B and 5C schematically illustrate a non-limiting example of implementation of a method according to a preferred embodiment of the present invention, wherein T=1 and P=2.

In particular, FIGS. 5A and 5B show a SAR system 50 that is installed on board, and is carried in flight/orbit along a flight direction d by, by an air/space platform (not shown in FIGS. 5A and 5B) such as an aircraft, a drone, a helicopter, a satellite or a spacecraft, whereby:
an azimuth direction x is defined by a ground track of the flight direction d on the earth's surface,
a nadir direction z is defined that is orthogonal to the earth's surface, to the flight direction d and to the azimuth direction x,
an across-track direction y is defined that lies on the earth's surface and is orthogonal to the azimuth direction x and to the nadir direction z.

More specifically, FIG. 5A shows a three-dimensional acquisition geometry, while FIG. 5B shows the acquisition geometry in the plane zy.

As shown in FIGS. 5A and 5B, at a given PRI, the SAR system 50 contemporaneously acquires a first portion A1 of a first swath S1 and a second portion A2 of a second swath S2, wherein:
said first and second swaths S1 and S2 are separated along the across-track direction y; and
the SAR system 50 contemporaneously uses two different radar beams that have different elevation angles with respect to the nadir direction z, are angularly separated in elevation (i.e., with respect to the nadir direction z) and are pointed, each, at a respective one of the first and second portions/swaths A1/S1 and A2/S2.

Additionally, FIG. 5C shows the acquisition geometry in time domain. In particular, as shown in FIG. 5C, in each PRI (wherein all the PRIs have one and the same predefined time length), the SAR system contemporaneously transmit towards and, then, contemporaneously receive from the first and second swaths S1 and S2, which are spaced apart from each other along the across-track direction y and from the SAR system 50 along a respective range direction (that extends from said SAR system 50 to, respectively, the first or second swath S1/S2) by predefined distances. Said predefined time length and said predefined distances are such that:
the radar echoes from the first portion A1 of the first swath S1 are received by the SAR system 50 after approximately three PRIs from the transmission, by said SAR system 50, of the corresponding radar signals that have illuminated said first portion A1 and, hence, have produced said radar echoes therefrom; while
the radar echoes from the second portion A2 of the second swath S2 are received by the SAR system 50 after approximately five PRIs from the transmission, by said SAR system 50, of the corresponding radar signals that have illuminated said second portion A2 and, hence, have produced said radar echoes therefrom.

In other words, the SAR acquisitions are organized in time domain so that the first and second swaths S1 and S2 have substantially one and the same distance within the same PRI. Obviously, the closest swath S1 is spaced apart from the SAR system 50 by a smaller distance than the second swath S2, but the time length of the PRIs is chosen so that the residue of the distance after an integer number of PRIs (rank) is similar. This allows to contemporaneously acquire the two separate swaths S1 and S2. The ambiguity performance is guaranteed by the angular distance and, hence, by the different antenna gain values. As previously explained, in order to increase range ambiguity performance, it is possible to use different squint angles with respect to the azimuth direction x and/or orthogonal waveforms.

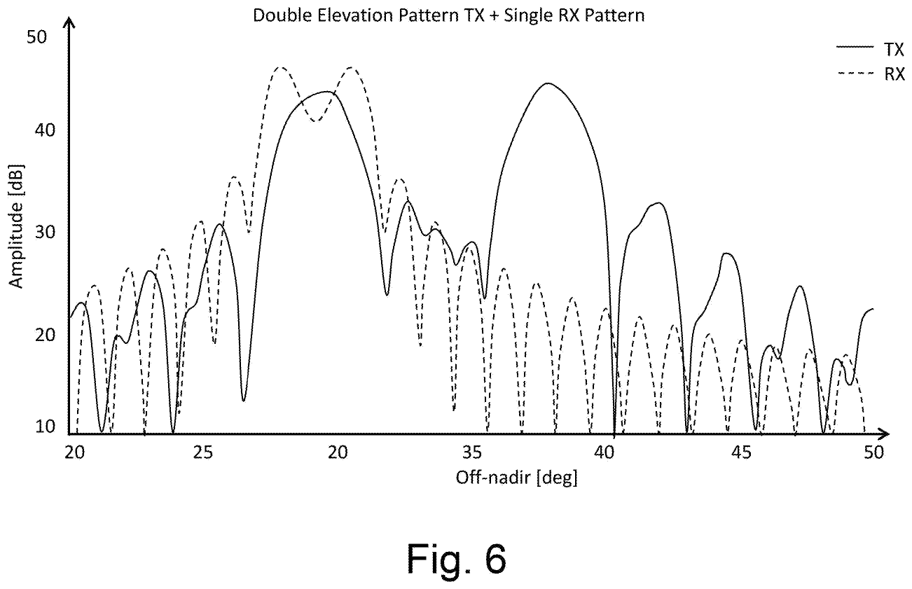

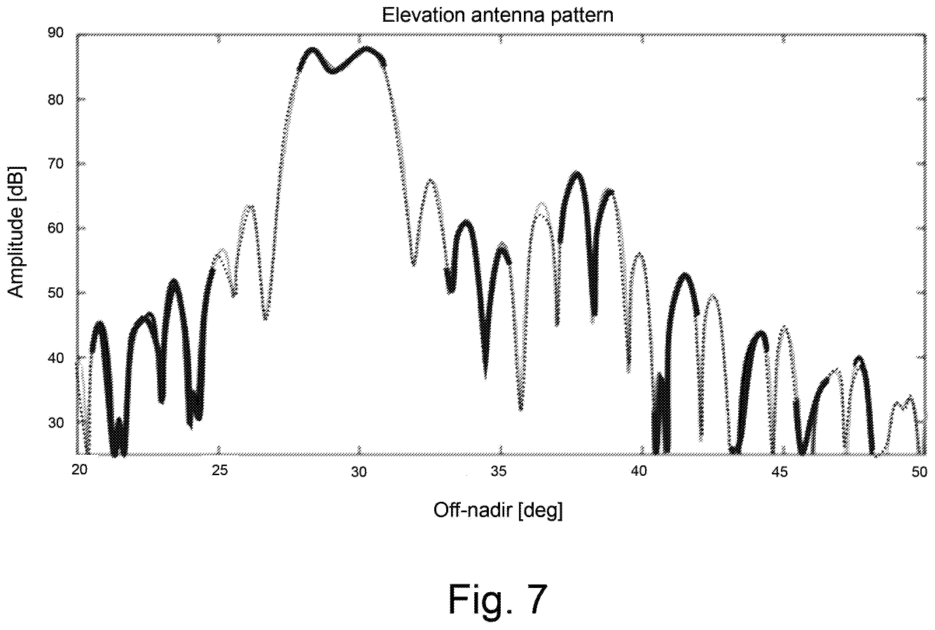

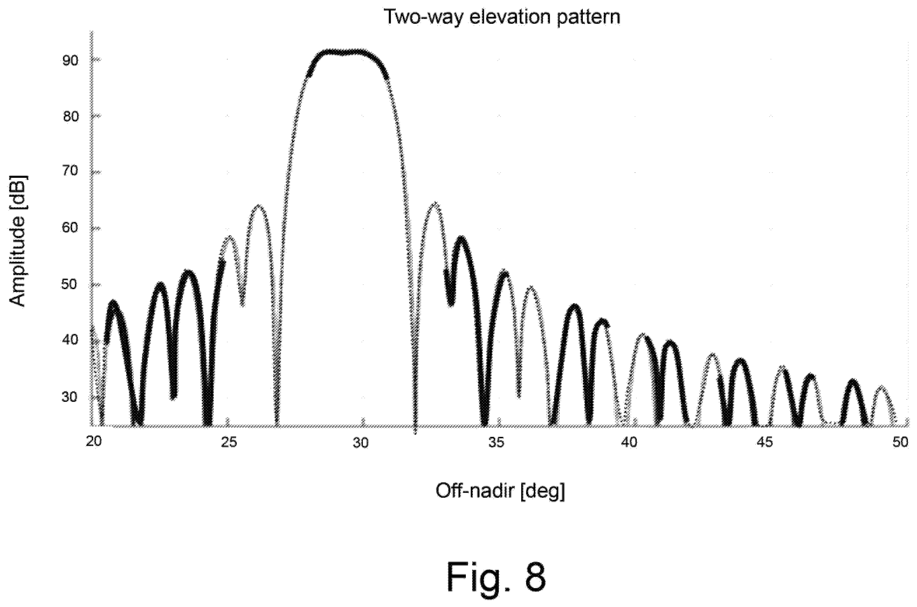

FIG. 6 shows an example of transmission pattern illuminating two different zones that are non-contiguous along the across-track direction, wherein T=1 and P=2. Instead, FIGS. 7 and 8 show the two-ways range pattern of each of the two channels. The two-ways range pattern is minimally altered with respect to the nominal case, as shown in FIGS. 7 and 8.

It is important to highlight that the present invention can be advantageously exploited with both Stripmap and Spotlight modes.

As previously explained, the present invention involves contemporaneous acquisition, within one and the same PRI, of P different and separate zones. This can be accomplished by means of different solutions based, for example, on multi-feed reflector antennas, active arrays or hybrid solutions (e.g., a reflector antenna fitted with an active array acting as feed thereof).

Hereinafter the case of an active array will be analyzed, remaining it clear that the same logic or equivalent ones may be applied, mutatis mutandis, also to other antenna typologies.

In particular, in the following, examples of different logic approaches usable with an active array will be described, wherein P is assumed, for simplicity, to be equal to two (i.e., P=2).

More specifically, when an active array is used in reception, two main logics may be conveniently exploited:

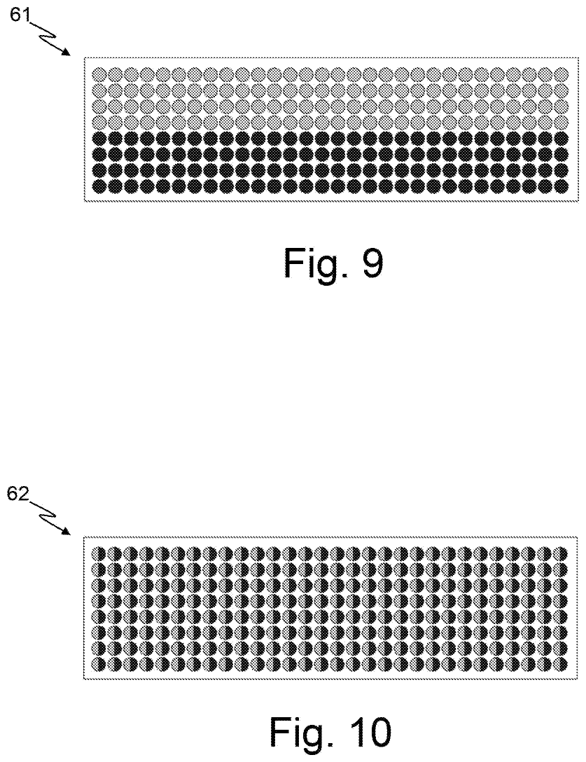

1) a partition in elevation of the antenna—namely, as shown in FIG. 9, the used antenna (in FIG. 9 denoted as a whole by 61) may be conveniently partitioned into two halves (more in general, into P portions) in elevation (i.e., along the nadir direction) and each half may be conveniently exploited to receive backscattered signal(s) from a different area; since, differently from the known SAR techniques, it is not necessary to acquire a single wide zone, it is possible to increase height of the antenna 61 so that each of the two halves is sized coherently with the area to be acquired; in this respect, it is worth noting that the space division techniques require acquisition of a wide swath in azimuth and, hence, require that the antenna be partitioned in azimuth so that the single sub-antennas have a predefined size depending on the desired resolution (namely, reduced by a factor that is at least equal to the desired resolution enhancement factor); therefore, differently from the present invention that allows to compensate the partition in elevation by a higher antenna, the space division techniques cannot use a longer antenna to recover directivity loss; in some cases, in order for the directivity loss to be recovered, the use of higher antennas has been proposed in the past but, since it is necessary to acquire the whole area, it is required that a further complication of dynamic beam re-pointing in elevation be introduced (so-called “SCan On Receive”);

2) an exploitation of the whole antenna (as shown in FIG. 10, where the antenna is denoted as a whole by 62) by digitally or analogically dividing the signal received by the single antenna elements into two parts (more in general, into P parts) and, then, by applying amplitude and phase modulations to each signal part to obtain the desired beams and, hence, to acquire the desired zones.

The first solution has an easier application but suffers a directivity loss of approximately a P factor (unless the height of the antenna is increased thereby completely preventing such a loss). On the contrary, the second solution does not affect the directivity.

Instead, in transmission, it is possible to use multiple solutions:

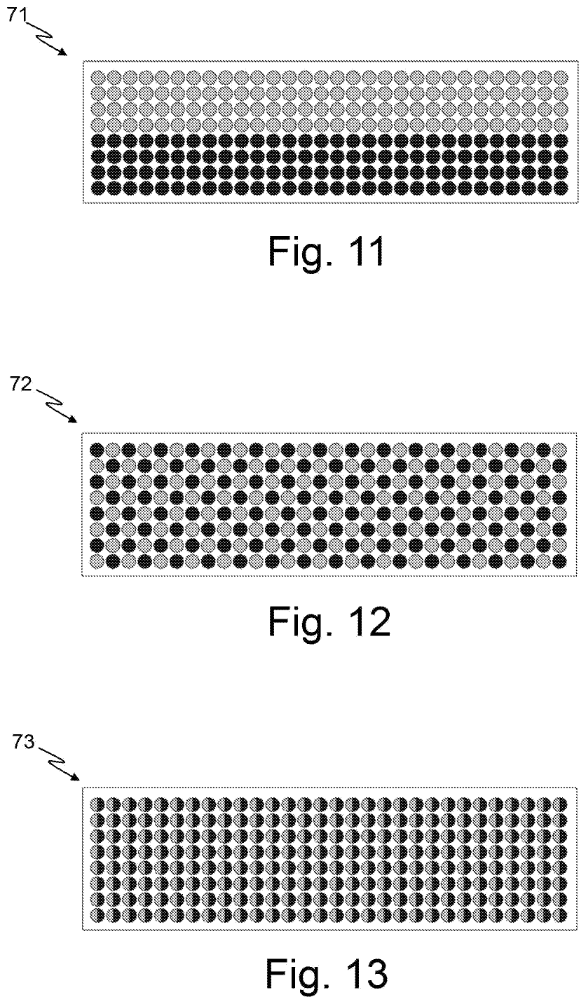

1) similarly to the first solution in reception, the used antenna may be conveniently partitioned into two halves (more in general, into P portions) in elevation; as shown in FIG. 11 (where the antenna is denoted as a whole by 71), each of the two halves will illuminate the desired zone; also in this case, in order to recover directivity, it is possible to increase the height of the antenna 71 without introducing other necessities;

2) as shown in FIG. 12, the antenna (denoted as a whole by 72) may be conveniently partitioned in homogeneous or chaotic blocks, whereby it is possible to modulate the single blocks in order to illuminate the desired areas; the impact on the directivity will depend on distribution of the single blocks and, hence, on the equivalent sampling of the single parts in which the antenna 72 is divided;

3) as shown in FIG. 13, the antenna (denoted as a whole by 73) may be conveniently partitioned in homogeneous blocks, complying with sampling requirements, whereby it is possible to modulate the single blocks in order to illuminate the desired areas; in this case there is no directivity alteration.

The following Table II summarizes the main differences between the present invention and the known SAR techniques.

TABLE II

| | DIFFERENCES WITH RESPECT TO |
|---|---|
| TECHNIQUE | THE PRESENT INVENTION |
| Angular Sharing (MEB) | The angular sharing technique involves the |
| | transmission of a large range beam and the |
| | simultaneous reception of different range- |
| | continuous zones and, in any case, the |
| | time constraint is not overcome. |
| | Instead, the present invention involves the |
| | contemporaneous acquisition (i.e., |
| | transmission and reception) of range- |
| | separated zones. |
| Time Sharing | The time sharing technique involves the |
| | acquisition of multiple non-contiguous zones, |
| | but not simultaneously. Additionally, the |
| | time sharing technique reduces the performance |
| | of the single acquisition (in term of swath |
| | size or of impulse response function quality). |
| | Instead, the present invention involves the |
| | contemporaneous acquisition of range- |
| | separated zones. |

In view of the foregoing, the technical advantages and the innovative features of the present invention are immediately clear to those skilled in the art.

In conclusion, it is clear that numerous modifications and variants can be made to the present invention, all falling within the scope of the invention, as defined in the appended claims.

1. Method for performing SAR acquisitions, comprising performing SAR acquisitions in Spotlight/Stripmap mode of areas/swaths of earth's surface by means of a synthetic aperture radar system carried by an air or space platform along a flight direction, whereby:
an azimuth direction is defined by a ground track of the flight direction on the earth's surface,
a nadir direction is defined that is orthogonal to the earth's surface, to the flight direction and to the azimuth direction,
an across-track direction is defined that lies on the earth's surface and is orthogonal to the azimuth direction and to the nadir direction, and,
for each acquired area/swath of the earth's surface, a respective range direction is defined that extends from the synthetic aperture radar system to said acquired area/swath;
wherein performing SAR acquisitions in Spotlight/Stripmap mode of areas/swaths of earth's surface includes contemporaneously acquiring, in a pulse repetition interval having a predefined time length, P areas or portions of P swaths by using:
P transmission radar beams that are angularly separated in elevation with respect to the nadir direction so as to be pointed, each, at a respective one of said P areas/swaths; and
P reception radar beams that are angularly separated in elevation with respect to the nadir direction so as to be pointed, each, at a respective one of said P areas/swaths;
wherein:
P is an integer greater than one;
the P areas/swaths are separated along the across-track direction and are spaced apart from each other along the across-track direction and from the synthetic aperture radar system along the respective range direction by predefined distances; and
said predefined time length and said predefined distances are such that to enable contemporaneous acquisition of said P areas or of the portions of said P swaths in said pulse repetition interval.

2. The method of claim 1, wherein the predefined time length and the predefined distances are such that to enable contemporaneous acquisition of said P areas or of portions of said P swaths in each pulse repetition interval.

3. The method of claim 1, wherein the SAR acquisitions in Spotlight/Stripmap mode are performed in a time division fashion, and wherein, in each pulse repetition interval, P respective areas or portions of P respective swaths are contemporaneously acquired by using:
P respective transmission radar beams that are angularly separated in elevation with respect to the nadir direction so as to be pointed, each, at a respective one of said P respective areas/swaths; and
P respective reception radar beams that are angularly separated in elevation with respect to the nadir direction so as to be pointed, each, at a respective one of said P respective areas/swaths;
and wherein:
for each pulse repetition interval, the respective P areas/swaths are separated along the across-track direction and are spaced apart from each other along the across-track direction and from the synthetic aperture radar system along the respective range direction by respective predefined distances;
the predefined time length and the respective predefined distances associated with the P respective areas/swaths contemporaneously acquired in each PRI are such that the areas or the swaths' portions acquired in T successive pulse repetition intervals form an overall region that is continuous along the across-track direction, T being an integer greater than one; and
the transmission and reception radar beams used in T successive pulse repetition intervals form an elevation-continuous angular span.

4. The method according to claim 1, wherein the SAR acquisitions in Spotlight/Stripmap mode are performed by using, in transmission and/or reception, an antenna of the synthetic aperture radar system partitioned into P different zones.

5. The method of claim 4, wherein the SAR acquisitions in Spotlight/Stripmap mode are performed by using, in transmission and/or reception, the antenna of the synthetic aperture radar system partitioned into P different zones in elevation.

6. The method according to claim 1, wherein the SAR acquisitions in Spotlight/Stripmap mode are performed by using different squint angles with respect to the azimuth direction and/or orthogonal waveforms such that to increase range ambiguity performance.

7. Synthetic aperture radar system installed on board an air or space platform and configured to carry out the method for performing SAR acquisitions as claimed in claim 1.

8. Space platform equipped with a synthetic aperture radar system configured to carry out the method for performing SAR acquisitions as claimed in claim 1.

9. The space platform of claim 8, wherein said space platform is a spacecraft or a satellite.

10. Air platform equipped with a synthetic aperture radar system configured to carry out the method for performing SAR acquisitions as claimed in claim 1.

11. The air platform of claim 10, wherein said air platform is an aircraft, a drone or a helicopter.
